(19) United States
(12) Patent Application Publication
(10) Pub. No.: US 2014/0283625 A1
(43) Pub. Date: Sep. 25, 2014

(54) SENSOR FOR MEASURING MECHANICAL TENSIONS IN A WIRE

(71) Applicant: RAFAEL GONZÁLEZ GALLEGOS, Madrid (ES)

(72) Inventor: RAFAEL GONZÁLEZ GALLEGOS, Madrid (ES)

(73) Assignee: DINACELL ELECTRONICA, SL, Madrid (ES)

(21) Appl. No.: 13/849,035

(22) Filed: Mar. 22, 2013

(51) Int. Cl. G01G 19/14

(52) U.S. Cl. CPC G01G 19/14
USPC 73/862.391

(57) ABSTRACT

A measurement device for measuring mechanical tensions in wires consisting of a metallic parallelepiped-shaped body (1), with a mechanical construction (4) for extensometric gauges from which supporting and fixing elements (2, 2′) stem from either one or both its faces, and which are provided with perimetric indentations. The supporting elements are three rods or rigid pivots arranged on the nodes of a tetractys pattern with respect to the longitudinal axis of the body, one of them (2′) being in an extremal position, mobile, retractile by shift both forwards and backwards in order to allow for it to be brought back to its forward operating position.

### BACKGROUND OF THE INVENTION

1. Field of the Invention

The invention, as expressed in the heading of the present description, concerns a device for measuring mechanical tensions in wires. More in particular, the object of invention revolves around a measurement device that has been improved in order to measure mechanical tensions in wires, which allows to weigh a mass hanging from it, enabling the operator to limit the charge levels when hoisting masses hanging from a wire, such as may occur in the case of load blocks, or a lifting device, e.g., an elevator, which is especially suited for the implementation of this measurement device. The scope of applicability of the present invention is circumscribed to the sector of industry devoted to the manufacturing of measuring devices, more in particular, those intended for the measurement of mechanical tensions on wires.

2. Brief Description of the Background of the Invention Including Prior Art

The measurement devices used so far have the problem of being made up out of unimodular bodies to which the wires whose mechanical tension need be measured or checked are held by means of displacement. Due to the natural tendency of the wires to recover their natural position, which has been previously forced in order to be able to bring them near the measurement device, the latter must be pushed towards the point where the wires are closest to each other.

Consequently, it would be necessary to have available some measurement device that would allow a location on a per wire basis, thus circumventing a forceful operation whenever an approximation of different wires is required. In reference to the state of the art, several documents are known divulging the existence of measurement devices designed to measure tension in wires of the kind here concerned, among which the most relevant to the case at hand on account of being the closest in concept are patents U.S. Pat. No. 3,653,258 A; DE 19605036 Al; U.S. Pat. No. 4,118,978 A; GB 2063494 A. Yet, none of them, whether considered independently or in combination, can be considered equivalent to the measurement device proposed here, as claimed.

### BRIEF SUMMARY OF THE INVENTION

The improved device for measuring mechanical tensions in wires that this application proposes is thus, configured as a novelty within its specific range of applicability, allowing on the one hand, for the measurement device to be built with dimensions small enough so that one measurement device can be placed on each wire, even if such wires are close to each other and without resulting in high-cost installations due to the simplicity of the measurement device itself.

The invention also presents the advantage of allowing a quick placement, which facilitates the installation of a large number of measurement devices in a considerably short amount of time, which also amounts to a reduction in potential installation costs.

This invention, at the same time, from what can be inferred from the configuration of the measurement device and its installation for every wire, allows one to compare the load difference between wires, enabling even the possibility of detecting loose or broken wires, and making it possible to automatically interrupt the service on security grounds. The measurement device can be endowed with built-in electronics, which would allow to signal the presence of loose wires by means of a flashing LED, placed on the measurement device itself, for which functionality the setting of the measurement devices forming a bus configuration can be arranged.

For all this, the measurement device for measuring mechanical tensions in wires that the present invention is proposing is made up of a parallelepiped-shaped body from which various ground-supporting and wire-supporting structures stem, within which an internal mechanical design is implemented that defines an area sensitive to mechanical strains, where extensometric gages are installed, which change their electrical resistance whenever the piece suffers a strain on the aforementioned strain-sensitive area, thus allowing for the deforming force on the material to be determined.

More in particular, the aforementioned body of the measurement device would preferably include three rods or pivots that conform the supporting points for the wire, to which the measurement device must be fixed, such pivots being arranged on one and the same face of the measurement device, and distributed along it, projecting orthogonally with respect to the plane defined by the face from which they project out, in positions corresponding to the nodes of a tetractys pattern with respect to the longitudinal axis of the body. A tetractys is a triangular figure of 10 points arranged in four rows with one, two, three, and four points arranged in each row, which is the geometrical representation of the fourth triangular number.

Furthermore, each pivot possesses an opening near its free end, through which the tight wire must pass. Such wire, as a consequence of the load, will be subject to a varying tension, acting on the pivots and transferring the effect of the deformation to the body of the measurement device, triggering the extensometric gage to generate the corresponding electrical signal, the reading of which allows one to assess the intensity of the load. On the other hand, in order to allow for the fixing of the previously described measurement device to be an easy, comfortable and quick-to-perform operation, as well as avoid the need to use special tools, so that such fixing can be done by means of a widely-available tool, such as a wrench, either adjustable or not, of the appropriate dimensions, the proposed measurement device is endowed with the following additional features:

On the one hand, two of the three pivots destined to hold the wire through their respective opening, are fixed with respect to the body of the measurement device, while the third one is mobile, retractile with respect to the body of the measurement device; i.e., movable either forward or backward by the operator so as to make it able to “disappear” as needed when attaching the measurement device to the wire, thus facilitating the assembly operation, while being able to “appear” again when the wire is already placed in the apertures of both of the fixed pivots or flanges and the body of the measurement device has been slightly rotated with respect to the wire so that the latter is not to obstruct the position through which that mobile pivot or flange will pass. Concurrently, the body of the flange presents, on its rear face, the appearance of an isolated stretch of surface area, bounded on both upper and lower borders by fringes that have been reduced in thickness in relation to the rest of the body, this surface area being of such a size and configuration as to allow the engaging of a conventional wrench of the appropriate kind, on which the operator is to perform the corresponding actions during the assembly for levering and carrying the body of the measurement device into the correct position so that the third pivot or flange can be pushed towards its operating position. It is easy to see how both features notably simplify the operative conditions and the time invested in completing the assembly of the measurement device on the wire whose mechanical tension one wishes to measure.

Finally, the addition of a protecting case is contemplated, which would provide a better finishing to the measurement device.

### BRIEF DESCRIPTION OF SEVERAL VIEWS OF THE DRAWING(S)

In order to complement the present description and to help obtain a better understanding of the invention, we adjoin several sheets of drawings to this description, as an integral part of it; and on which, with a character that should be understood as illustrative and not limiting, the following has been represented:

FIG. 1. corresponds to a first side elevational view, displaying a partial cross section of the device for measuring mechanical tensions that is the object of the present invention,

FIG. 2. represents a top plan view of the measurement device shown in FIG. 1,

FIG. 3. represents a front view in elevation, from one of the smaller sides, of the measurement device shown in the previous figures,

FIG. 4a shows another second side elevational view,

FIG. 4b shows another second side elevational view,

FIG. 4c shows a bottom plan view of the measurement device,

FIG. 4d shows a top plan view of the measurement device shown in FIG. 4a, wherein the FIGS. 4a, 4b, 4c, and 4d show successive views as seen from different positions of a measurement device, according to the invention specifications,

FIG. 5a shows a top plan view of the measurement device according to the invention,

FIG. 5b shows a top plan view of the measurement device together with a wire,

FIG. 5c corresponds to the first side elevational view,

FIG. 5d shows a top plan view of the measurement device according to the invention,

FIG. 5e a bottom planar view

FIG. 5f corresponds to the first side elevational view

FIG. 5g shows a top plan view of the measurement device according to the invention,

FIG. 5h shows a perspective view of the top plan view of the device together with a projecting case,

FIG. 5i shows a perspective view of the invention device enclosed by the projecting case,

FIG. 5j shows a perspective view of the measurement device surrounded by a projecting case, wherein FIGS. 5a to 5j show diverse representations corresponding to ten positions that constitute an operative sequence related to the assembly of the measurement device of this invention on a wire.

### DETAILED DESCRIPTION OF THE INVENTION

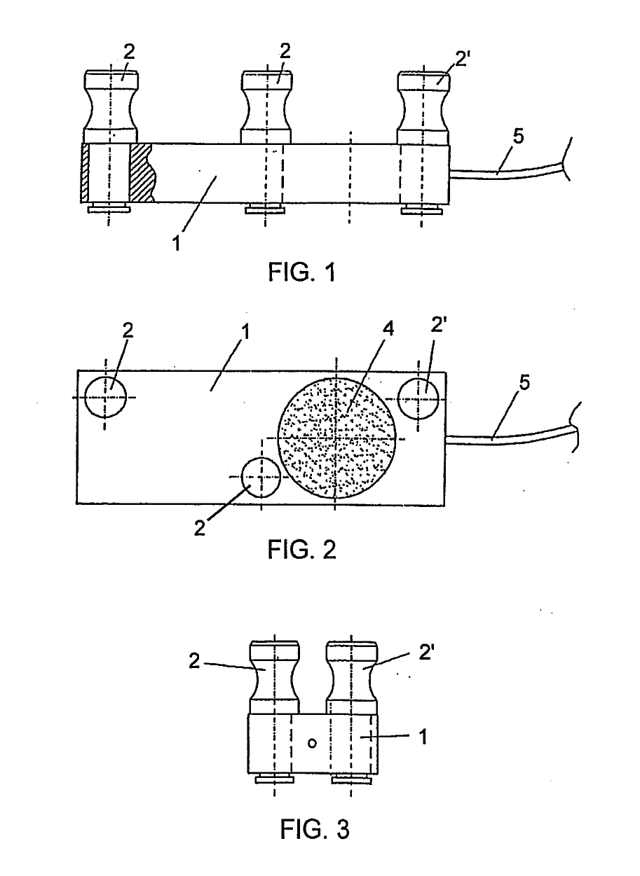

Based on the aforementioned figures and according to the adopted numbering, we can appreciate on the measurement devices an example of the implementation of the measurement device for measuring mechanical tensions in wires which is the object of the present invention, of which the different parts and elements are indicated and described in detail in what follows. Thus, as can be seen in FIGS. 1 to 3, the measurement device in question is made up of a parallelepiped-shaped body (1), built of a metallic material, from which body (1) supporting elements (2, 2′) stem in order to attach measurement device to the wire (3), having the body (1) with a mechanical construction (4) consisting in an area sensitive to mechanical strains within which extensometric gages are placed (neither represented nor referenced), about which it must be specified that such extensometric gages change their electrical resistance whenever the piece that constitutes the body (1) suffers a mechanical strain near the area where the aforementioned mechanical construction (4) is located. An extensometric gage is an instrument for measuring minute degrees of expansion, contraction, or deformation. With this we can determine the deforming force on the material. The aforementioned supporting elements (2, 2′) are, preferably, three rods or rigid pivots, although obviously there could be more, that project through one of the faces of the parallelepiped-shaped body (1), even though they could also go through it coming out through the opposite face in order to attach the measurement device to a couple of wires, or even such rigid pivots could be extended up to another similar measurement device so that the measurement of mechanical tension is possible on an arbitrary number of lined-up wires that are placed between both measurement devices.

In any case, such supporting elements (2, 2′) in the shape of pivots projecting perpendicular to the plane of the face above indicated of the body (1) of the measurement device, emerging from predetermined positions along such face, at both sides of its longitudinal axis. The invention is enabled to allow for the supporting elements (2, 2′) to present different dimensions in order to attach the measurement device to a couple of very close wires, both wires being placed at the same side with respect to the measurement device. The supporting elements (2, 2′), minimally change the direction of the wire, forcing it to follow the shape of a “V”, whose defining angle tends to open up whenever the mechanical tension grows, inducing a deformation on the measurement device at the location where the mechanical construction sensitive to deformations (4) is placed.

In order to obtain an adequate attachment of the measurement device to the wires, it has been provided that the attaching supporting elements (2, 2′) are endowed with perimetric indentations or peripheral indentations, whose function is to guide the wire.

In order to facilitate the installation, two of the supporting elements are fixed (2) to the body (1) of the measurement device, while the third one is mobile (2′) and, in one of the embodiment options, it would be placed by means of a drilling at the place destined to its location at the moment of installation; or, in a further alternative option, it would be retractile, as will be explained below.

The wire-guiding perimetric indentations or peripheral indentations guarantee that the third supporting element (2′) cannot move from its position, as the remaining supporting elements (2), along with the wire (3), define a unique third supporting element in a plane parallel to the face of the parallelepiped-shaped body (1) on which all the supporting elements (2, 2′) are placed.

In order for the sensor to actually be supported on the wire a minimum of mechanical tension is necessary on such wire, which is always the case in lifts and the like.

The interior of the body (2) of the measurement device (1) is amenable to the inclusion of integrated electronics, which would allow for signal amplification, or even to connect several measurement devices in a bus configuration with microprocessor electronics.

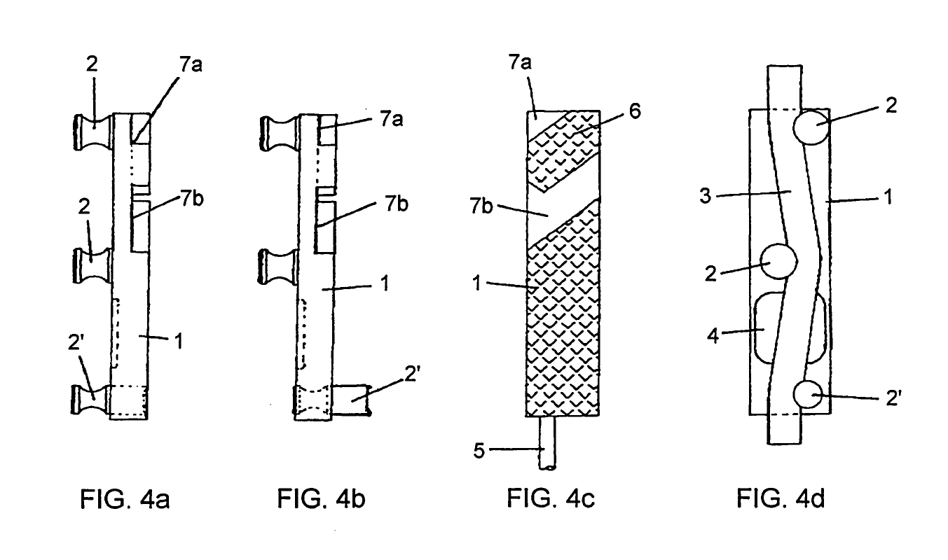

As concerns representations in FIGS. 4a and 4d, it can be appreciated how, in one embodiment option for this invention, one of the supporting elements or extremal pivots, indicated with the reference (2′) in the figures, is mobile in its positioning; that is to say, it can be displaced forward and backward with respect to the parallelepiped-shaped body (1) of the measurement device, in order to make the assembly of the measurement device easier, as pointed out before.

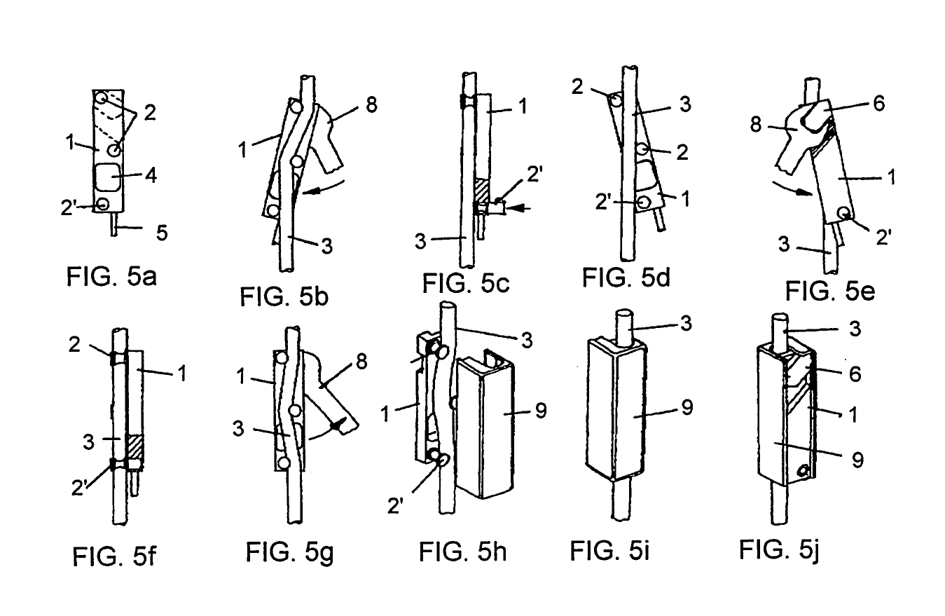

Thus, in FIG. 4a we can see the mobile supporting element (2′) in the position shifted forward; i.e., a position equivalent to the fixed supporting elements (2), while in FIG. 4b it has been represented as shifted backward, projecting out with respect to the rear part of the parallelepiped-shaped body (1). As customary, the body (1) incorporates a mechanical construction (4) in order to host the corresponding extensometric gage in charge of generating the electrical signals and send them to the control device by means of an electric wire (5). Besides, FIG. 4d shows that the trajectory of the mechanical wire (3) between supporting elements (2, 2′) is realized by following the same path as in already existing measurement devices (1). As concerns FIG. 4c, we can appreciate the representation of an elevation view corresponding to the rear side of the body (1), to the effect of displaying the constituents of an isolated surface portion (6), as a result of the making of two surface lowerings (7a, 7b) or fringes defining upper and lower limits on it. This is precisely the portion that is intended for the operation by means of any appropriate conventional wrench, either adjustable or not, with which to exert a rotating action against the resistance opposed by the tension of the wire (3) during the assembly and coupling procedures of the measurement device to the latter. In the various representations of FIGS. 5a and 5j, an operative sequence can be appreciated which follows during the assembly of a measurement device conforming to the invention; on a wire on which the mechanical tension we wish to measure.

In the FIG. 5a we can see a schematic representation of a front-side elevation view of the body (1) of the measurement device with the fixed supporting elements (2), and with the mobile supporting element (2′) on the lower part.

In the FIG. 5b we can see the measurement device with the wire (3) already placed between the supporting elements (2, 2′), and with a wrench 8, used during the assembly procedure, projecting out from the rear side of the body (1).

In order to reach such coupling condition, FIG. 5c shows an elevation view from one lateral of the body (1) of the sensor with the mobile supporting element (2′) shifted backwards, which allows an easy and comfortable placing of the sensor having the wire (3) pass between both fixed supporting elements (2) by means of a slight tilting of the body (1) of the sensor, as shown in FIG. 5d of the sequence.

In the representation of FIG. 5e we can appreciate the body (1) of the sensor with the wrench (8) acting on the surface portion (6) of its rear side. The representation of FIG. 5f shows the mobile supporting element (2′) already shifted forward, in its operating position, with the wire (3) placed in its indentation, which is done with the help of wrench (8) by means of which a leverage is exerted to rotate the body (1) of the measurement device, against the tension of the wire (3), so as to bring it to a position such that the corresponding mobile supporting element (2′) is able to accommodate the wire, as can be more clearly seen in the representation of FIG. 5g. Once the wire has been coupled to the three supporting elements (2, 2′), the set can be completed, preferably, with the help of a protecting case (9), which is attached to the parallelepiped-shaped body (1) by sheer coupling pressure, being kept in place by the latter, such as can be seen in FIGS. 5h, 5i and 5j of the operative sequence. We do not deem it necessary to further belabor the contents of this description for an expert in these matters to be able to understand the scope and associated advantages of this invention, as well as develop and put to practice the object of it.

Notwithstanding the above, it must be understood that the present invention has been described following a preferential embodiment of it, on account of which it is susceptible of modifications without it in any way implying essential alterations of the foundations of the invention, such alterations potentially involving the shape, size and/or materials used in the manufacturing.

1. A measurement device for measuring mechanical tensions in wires comprising
a parallelepiped-shaped body (1) tangibly elongated and made of metallic material,
supporting and wire-fixing elements (2, 2′) attached to the parallelepiped-shaped body,
perimetric indentations furnished at the supporting and wire-fixing elements (2, 2′) destined to keep a wire (3) in place,
a mechanical construction (4) furnished on a surface of the parallelepiped-shaped body (1) to house extensometric gages generating signals corresponding to the levels of load on the wire (3) on which the load is installed, wherein such supporting and wire-fixing elements (2, 2′) project out through at least one of the faces of the parallelepiped-shaped body (1), wherein the supporting and wire-fixing elements (2, 2′) are distributed throughout such face and are orthogonally projecting with respect to the plane of the face through which the supporting and wire-fixing elements (2, 2′) emerge.

2. The measurement device for measuring mechanical tensions in wires, according to claim 1, wherein the supporting and wire-fixing elements (2, 2′) are three rigid rods of pivots that project out through one of the faces of the parallelepiped-shaped body (1) placed on the nodes of a tetractys pattern with respect to the longitudinal axis of this parallelepiped-shaped body (1).

3. The measurement device for measuring mechanical tensions in wires, according to claim 1, wherein the supporting and wre-fixing elements (2, 2′) have different dimensions.

4. The measurement device for measuring mechanical tensions in wires, according to claim 1, wherein one (2′) of the supporting and wire-fixing elements, in an extremal position, is mobile, retractile and withdrawable by shifting forward and backward, in such a way that it can be hidden away by backward shift during the first stage of the assembly of the measurement device on the wire (3), and then brought back to the forward operative position when the body (1) of the measurement device has been brought to the appropriate position against the resistance to flexing by the mechanical tension induced by the load on such cable (3); and because the body (1) of the measurement device has been endowed, on its rear face, with an isolated surface portion (6), bounded by lowered fringes (7a, 7b) upper and lower, such surface portion being sized and configured in such a way that it allows the engaging of a tool, such as a wrench (8), either adjustable or not, with which to exert a levering action during the operation of rotating the body (1) of the measurement device in order to attach the wire (3) to the supporting elements, both fixed (2) and mobile (2′).

5. The measurement device for measuring mechanical tensions in wires, according to claim 1, wherein the provision of incorporating a protecting case (9), is adaptable and fixable by sheer pressure to the body (1) of the sensor.

6. A measurement device for measuring mechanical tensions in wires which, being of the kind made out of a parallelepiped-shaped body (1) tangibly elongated of metallic material, presenting supporting and wire-fixing elements (2, 2′) endowed with a perimetric indentation destined to keep the wire (3) in place and having the body (1) on its surface a mechanical design (4) to house extensometric gages generating the signals corresponding to the levels of load on the wire (3) on which it is installed, wherein such supporting elements (2, 2′) project out through at least one of the faces of the body (1), distributed throughout such face and orthogonally projecting with respect to the plane of the face through which they emerge.

7. The measurement device for measuring mechanical tensions in wires, according to claim 6, wherein the supporting elements (2, 2′) are three rigid rods of pivots that project out through one of the faces of the body (1) placed on the nodes of a tetractys pattern with respect to the longitudinal axis of this body.

8. The measurement device for measuring mechanical tensions in wires, according to claim 6, wherein the supporting elements (2, 2′) have different dimensions.

9. The measurement device for measuring mechanical tensions in wires, according to claim 6, wherein one (2′) of the supporting elements, in extremal position, is mobile, retractile by shift forward and backward, in such a way that it can be hidden away by backward shift during the first stage of the assembly of the sensor on the wire (3), and then brought back to the forward operative position when the body (1) of the sensor has been brought to the appropriate position against the resistance to flexing by the mechanical tension induced by the load on such cable (3); and because the body (1) of the measurement device has been endowed, on its rear face, with an isolated surface portion (6), bounded by lowered fringes (7a, 7b) upper and lower, such surface portion being sized and configured in such a way that it allows the engaging of a tool, such as a wrench (8), either adjustable or not, with which to exert a levering action during the operation of rotating the body (1) of the sensor in order to attach the wire (3) to the supporting elements, both fixed (2) and mobile (2′).

10. The measurement device for measuring mechanical tensions in wires, according to claim 6, wherein the provision of incorporating a protecting case (9), is adaptable and fixable by sheer pressure to the body (1) of the measurement device.
